(19) United States
(12) Patent Application Publication
(10) Pub. No.: US 2009/0016251 A1
(43) Pub. Date: Jan. 15, 2009

(54) Management method and system of low power consuming devices

(75) Inventors: Lewis Adams, Carmel, CA (US); Pankaj Vyas, Bangalore (IN)

Correspondence Address: MURABITO, HAO & BARNES, LLP, TWO NORTH MARKET STREET, THIRD FLOOR, SAN JOSE, CA, 95113, US

(73) Assignee: Gainspan, Inc.

(21) Appl. No.: 11/827,879

(22) Filed: Jul. 13, 2007

(51) Int. Cl. G08C 17/00

(52) U.S. Cl. 370/311

(57) ABSTRACT

Management method and system of low power consuming devices are disclosed. In one embodiment, a method includes monitoring a heartbeat signal of a device communicated through a network, and communicating with the device upon processing the heartbeat signal of the device. In another embodiment, a system includes one or more devices to individually generate a heartbeat signal and a control point to communicate with each of the devices based on the heartbeat signal processed through the control point.

### FIELD OF TECHNOLOGY

This disclosure relates generally to technical fields of software and/or hardware and, in one embodiment, to management method and system of low power consuming devices.

### BACKGROUND

Devices (e.g., wired and/or wireless devices) limit their communication with a base station (e.g., a management device) so that they only communicate when it is absolutely necessary in order to conserve battery power. Since the base station often keeps track of the devices based on its communication with the devices, an inactive device may not be easily distinguishable from a device leaving the network. For example, the inactive device (e.g., for extended periods) may appear to have left the network. Conversely, the device that breaks, gets thrown away, and/or simply gets removed may still appear on the network since it was once a member.

If there is a disruption in the network between the devices and the base station, the device (e.g., a sensor node) may need to retry its transmission a number of times before it determines the base station (e.g., upstream device) is unreachable. These retransmissions consume power which reduces battery life. Additionally, communications with other devices (e.g., the base station or other sensor nodes) physically distant from the device have larger round trip latency and/or jitter which consume more power than devices that are close to the device.

### SUMMARY

Management method and system of low power consuming devices are disclosed. In one aspect, a method includes monitoring a heartbeat signal of a device communicated through a network, and communicating with the device upon processing the heartbeat signal of the device.

The method may further include removing the device from an active device list of a control point (e.g., which may resides in an access point, a radius server, a proxy server, and/or a host server) when a heartbeat signal of the device is not detected past a threshold value. The method may also include temporarily holding data destined for the device in a data queue associated with the control point until the processing the heartbeat signal is completed or the device is ready to process the data. The method may further include authenticating the device or the control point through exchanging security keys between the device and the control point. Additionally, the method may include enabling a user to access the control point from a remote location in the network. Moreover, the method may include communicating a command data to the device to alter a state or a function of the device.

In another aspect, a system includes one or more devices to individually generate a heartbeat signal (e.g., which may indicate a wake-up mode of the each of the one or more devices), and a control point to communicate through a network with each of the one or more devices based on the heartbeat signal processed through the control point.

The system may further include a liveness module of the control point to update a status of the each of the one or more devices based on the heartbeat signal. The system may also include a store and forward module (e.g., which may temporarily hold the device data communicated from the first device until the second device is ready to process the device data) of the control point to communicate a device data of a first device of the one or more devices to a second device of the one or more devices. In addition, the system may include an auxiliary control point to replace the control point (e.g., which may periodically update a status of the each of the one or more devices to the auxiliary control point) when the control point fails to communicate with the auxiliary control point (e.g., which may assume an internet protocol address of the control point replacing the control point).

Furthermore, the system may include an access module of the control point to provide a tiered access to a user of the system through collaborating with an authentication server communicatively coupled to the access module. The system may also include a remote module of the control point to enable the user to log on to the control point from anywhere in the network. Additionally, the system may include an aggregation module of the control point to aggregate data from any subset of the one or more devices. The system may also include a presentation module of the control point (e.g., which may reside anywhere in the network including an access point, a radius server, a proxy server and/or a host server) to present the data from the any subset of the one or more devices.

In yet another aspect, an apparatus includes a control point to communicate with a device upon processing a heartbeat signal of the device. A status or a function of the device may be updated upon authenticating the control point or the device based on the heartbeat signal.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a network view of a low power system on chip interacting with a controller and/or a number of external devices, according to one embodiment.

FIG. 2 is a schematic diagram of a low power wireless system on chip (SOC) having a real time counter module islanded from the rest of the low power system on chip, according to one embodiment.

FIG. 3 is an interaction diagram of software modules of the low power wireless SOC of FIG. 2, according to one embodiment.

FIG. 4 is a state diagram of the low power wireless SOC of FIG. 2, according to one embodiment.

FIG. 5 is a system diagram of a control point managing wireless devices associated with a central base station in a wireless network, according to one embodiment.

FIG. 6 is a process flow diagram of an algorithm implemented in the control point of FIG. 5 to perform one or more functions associated with the wireless devices, according to one embodiment.

FIG. 7 is a low power wireless SOC interacting with a host server through an access point, according to one embodiment.

FIG. 8 is a diagrammatic system view of a data processing system in which any of the embodiments disclosed herein may be performed, according to one embodiment.

Other features of the present embodiments will be apparent from the accompanying drawings and from the detailed description that follows.

### DETAILED DESCRIPTION

Management method and system of low power consuming devices are disclosed. In the following description, for purposes of explanation, numerous specific details are set forth in order to provide a thorough understanding of the various embodiments. It will be evident, however, to one skilled in the art that the various embodiments may be practiced without these specific details.

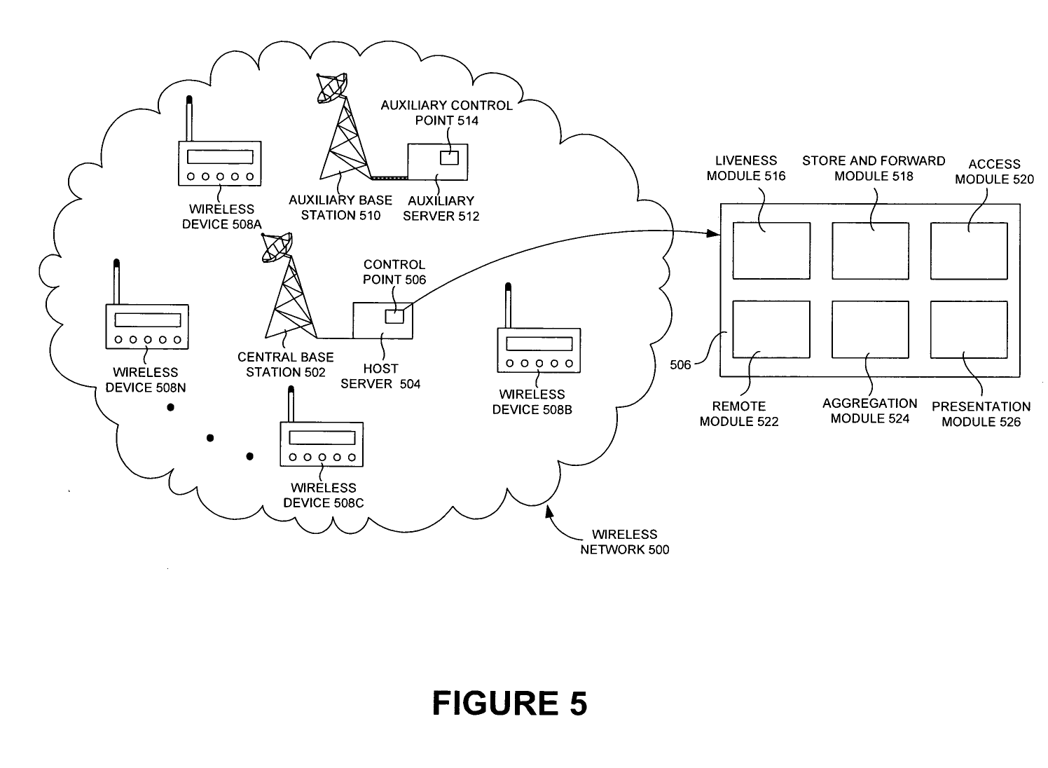

In one embodiment, a method of a control point in a network includes monitoring a heartbeat signal of a device (e.g., the wireless device 508 of FIG. 5) communicated through the network (e.g., the wireless network 500), and communicating with the device upon processing the heartbeat signal of the device. In another embodiment, a system includes one or more devices to individually generate a heartbeat signal, and a control point (e.g., the control point 506) to communicate with each of the one or more devices based on the heartbeat signal processed through the control point. In yet another embodiment, an apparatus includes a control point to communicate with a device upon processing a heartbeat signal of the device.

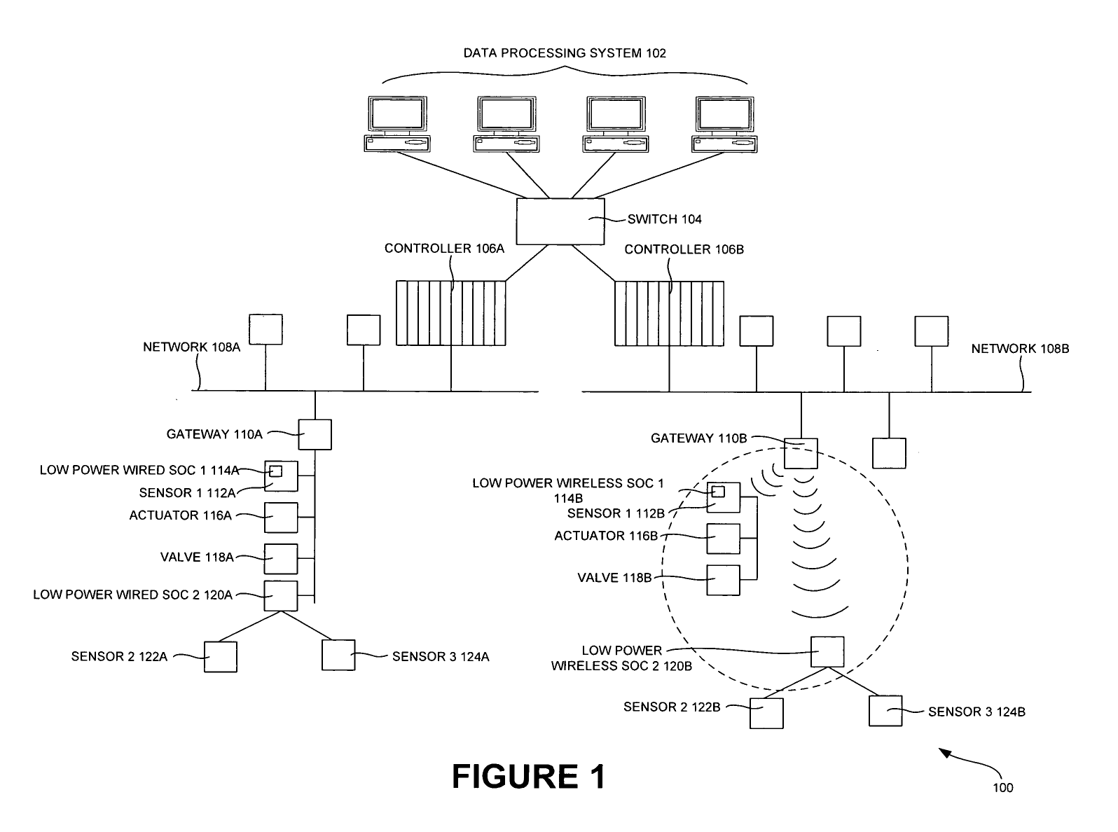

FIG. 1 is a network view of a low power system on chip 114 interacting with a controller 106 and/or a number of external devices, according to one embodiment. The low power system on chip (SOC) 1 114 (e.g., the low power wired SOC 1 114A and/or a low power wireless SOC 1 114B) embedded in a sensor 112 may connect the number of external devices (e.g., the sensor 1 112, an actuator 116, a valve 118, etc.) to a gateway 110 (e.g., an access point). The gateway 110 may be connected to a network 108 (e.g., a WAN, a LAN, a WLAN, an internet, etc.) which may in turn be connected to other gateways communicating with other devices.

A low power SOC 120 (e.g., a low power wired SOC 2 120A and/or a low power wireless SOC 2 120B) may also externally control a sensor (e.g., a sensor 2 122 and/or a sensor 3 124). The network 108 (e.g., the network 108A and/or the network 108B) may be connected to the controller 106 (e.g., the controller 106A and/or the controller 106B) which is used to control a transmission of data over the network 108, the devices, and/or a switch 104 (e.g., which may be used to regulate the transmission of data between a data processing system 102 and/or the controller 106).

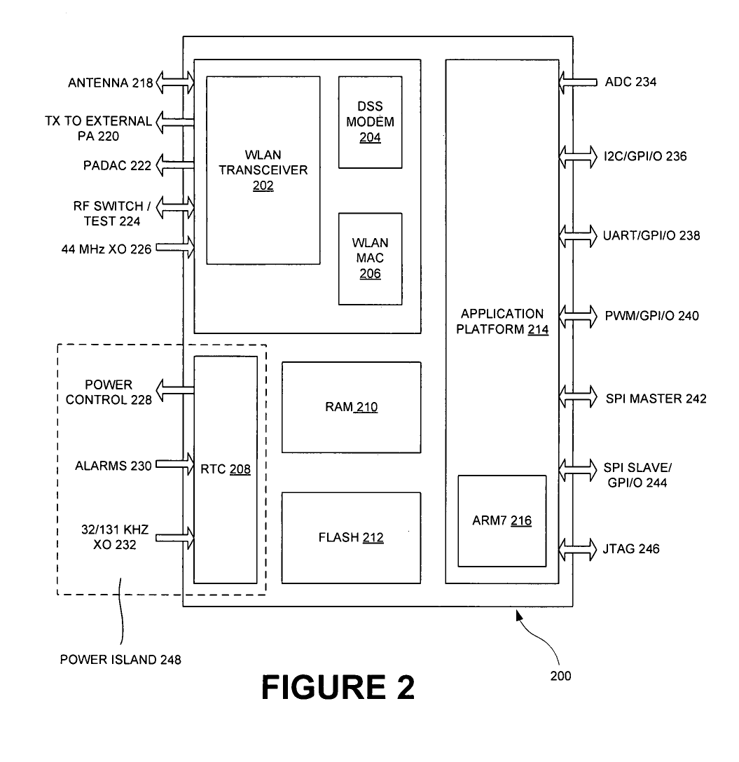

FIG. 2 is a schematic diagram of a low power wireless system on chip (SOC) 200 having a real time counter module 208 islanded from the rest of the low power system on chip, according to one embodiment. The low power wireless SOC 200 includes a dual-processor system (e.g., ARM7 216 based) with a direct-sequence spread spectrum (DSSS) Modem 204 (e.g., an IEEE 802.11b) and a WLAN transceiver 202 in a single chip. The low power wireless SOC 200 may be used by a wireless facility to monitor environmental conditions (e.g., a temperature, an occupancy, a humidity, a radiation, a vibration, a pressure, etc.).

In one example embodiment, the low power wireless SOC 200 may have a 2.4 GHz complementary metal-oxide-semiconductor (CMOS) WLAN transceiver 202, which may have an embedded power amplifier (PA) with a programmable output power (e.g., up to 12 dBm). The PA output may be merged with low-noise amplifier (LNA) inputs. The direct-sequence spread spectrum (DSSS) modem 204 may modulate for data rates (e.g., 1 Mb/s and/or 2 Mb/s). A transmitted signal of the DSSS modem 204 may take up more bandwidth than an information signal that is being modulated (e.g., where the name ‘spread-spectrum’ comes from the fact that the carrier signals occur over the full bandwidth (spectrum) of the device's transmitting frequency).

The DSSS modem 204 may multiply the data being transmitted by a noise signal, which is a pseudorandom sequence of 1 and −1 values, at a frequency much higher than that of original signal, thereby spreading energy of the original signal into a much wider band. The resulting signal may resemble a white noise, except that the resulting signal may be filtered out at a receiving end to recover the original signal by multiplying the same pseudorandom sequence to the received signal (because 1×1=1, and −1×−1=1).

As shown in FIG. 2, the low power wireless SOC 200 may have a WLAN medium access control (MAC) 206, which provides addressing and channel access control mechanisms that makes it possible for several terminals and/or network nodes to communicate with the WLAN transceiver 202. The MAC data communication protocol sub-layer may be a part of a seven-layer OSI model data link layer (layer 2). The MAC sub-layer may act as an interface between the Logical Link Control sub-layer and the network's physical layer. The MAC layer may provide an addressing mechanism called physical address or MAC address (e.g., a unique serial number which may be assigned to each network adapter, making it possible to deliver data packets to a destination within a sub-network, which may be a physical network without routers (e.g., an Ethernet LAN, a WLAN, etc.). The low power system on low power wireless SOC 200 may include high-throughput hardware with two small private random access memories (RAM) for encryption/decryption, hardware co-processing for demanding lower-MAC tasks and hardware support of IEEE 802.11i, (e.g., Counter Mode with Cipher Block Chaining Message Authentication Code Protocol (CCMP), which is a full security IEEE 802.11i encryption protocol).

The application platform (APP) 214 may be a dual processor platform which may include two ARM7 216, one to run the WLAN software and the other to run the application software, running at specified frequency (e.g., 11, 22, 44 MHz). The ARM architecture may be a 32-bit reduced instruction set computer (RISC) architecture that may widely be used in a number of embedded designs. Due to their power saving features, ARM central processing units (CPU) are dominant in the mobile electronics market, where low power consumption is a critical design goal. The APP may be based on two separated AMBA high performance busses (AHB) to maximize the bandwidth allowed to each CPU (e.g., to avoid time-sharing when using the bus so that both CPUs are fully operational at all times). The CPUs may also be equipped with Joint Test Action Group (JTAG) test access ports 246 for hardware debug purposes.

The low power wireless SOC 200 may include a random access memory (RAM) 210 including a shared memory of 192K bytes for both CPUs and dedicated RAM of 32K bytes for the WLAN CPU. The shared RAM may be mainly used by the APP CPU and may contain the data frames for inter-CPU communication. However, the shared RAM may also be used by the WLAN CPU during software update procedures and for future extensions of the WLAN stack if feasible. As illustrated in FIG. 2 the low power wireless SOC 200 also may have 384K bytes of embedded Flash memory 212 which may be used to update firmware. On-chip start-up code may be located in a dedicated boot ROM which may be divided for the use of each CPU.

FIG. 2 also illustrates a Real Time Clock (RTC) 208 which may provide global time and/or date to the low power wireless SOC 200. The RTC 208 may contain a low-power crystal oscillator that supports a 32.768 kHz crystal and/or a 131.072 kHz crystal 232. The RTC 208 may run on a dedicated power supply, ranging between 1.2V and 3.6V. Three programmable wrap-around alarm counters may be provided to enable periodic wake-up of the low power wireless SOC 200 and two independent external components. Two alarm inputs 230 (e.g., external) may enable wake-up of the low power wireless SOC 200 on external events.

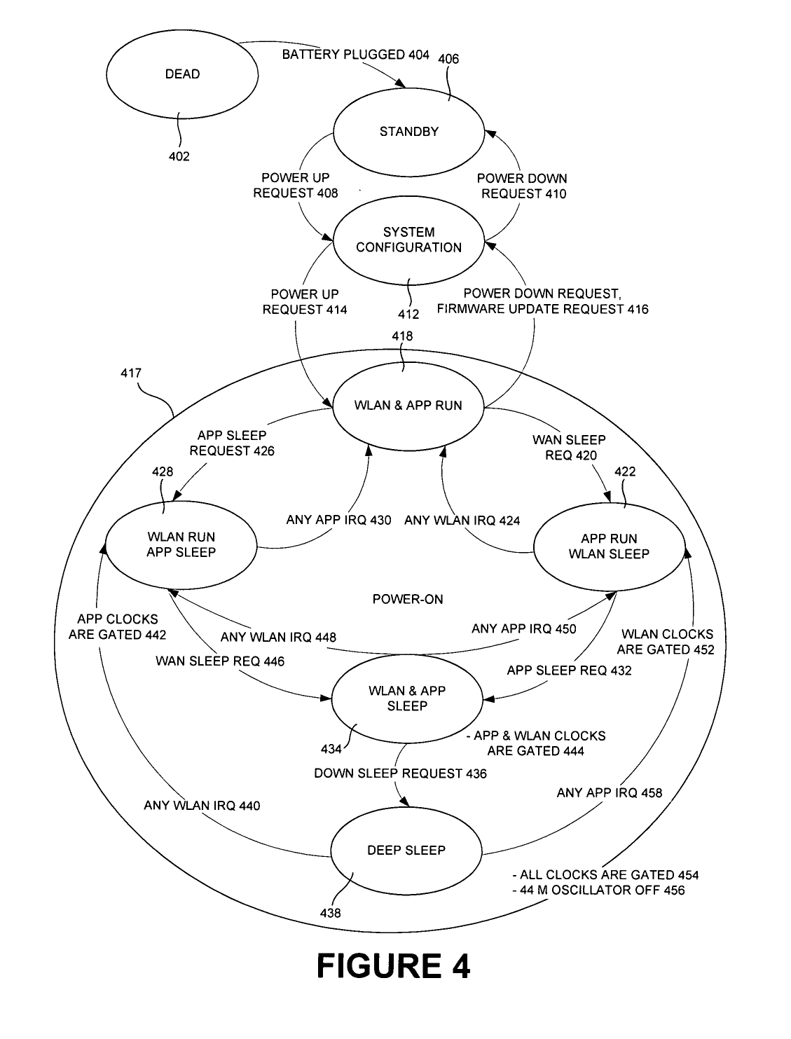

Interfaces may include support of an external serial E²PROM parameter memory and/or a serial flash data memory through a serial peripheral interface (SPI), two multi-purpose universal asynchronous receiver/transmitter (UART) interfaces 238, external CPU interfaces via SPI master 242 and SPI slave/GPI/O 244 interface, up to 32 General Purpose I/Os, three pulse-width modulated (PWM) function outputs 240, and I²C master and slave interface 236. The interfaces may also include support for two 10 bits 32K samples/ ADC channels 234, two alarm inputs 230, three control outputs for power supply 228, external radio frequency (RF) switches/test 224, and support for external power amplifier, such as, dedicated transmitter (Tx) output 220 and/or PA digital-to-analog converter (DAC) output 222. The low power wireless SOC 200 may be connected to an antenna 218 to receive and/or transmit data to and/or from an access point. Along with low-power modes to be described in FIG. 4, the low power wireless SOC 200 may also have power supply monitoring and/or temperature monitoring capabilities. These features may help the device be alert for over and under voltage fault conditions.

Furthermore, a hardware module of the low power wireless SOC 200 (e.g. which includes one or more of a microcontroller, a microprocessor, a DSP core, a memory, a timing source, a peripheral, an external interface, etc.) may have the real time counter (RTC) 208 of the peripheral isolated from a rest of the hardware module using more than one voltage level shifting cells and/or more than one voltage island cells (e.g., which is placed between the RTC 208 and the rest of the hardware module such that two different voltages are separately applied to the RTC 208 and the rest of the hardware module). Also, a software module (e.g., of the application platform 214) associated with the RTC 208 may generate one or more control signals to one or more devices external to the low power wireless SOC 200 during a sleep mode (e.g., the sleep mode places any unused part of the low power wireless SOC 200 in a non-operational mode to reduce power consumption) of the low power wireless SOC 200 to communicate with the one or more devices.

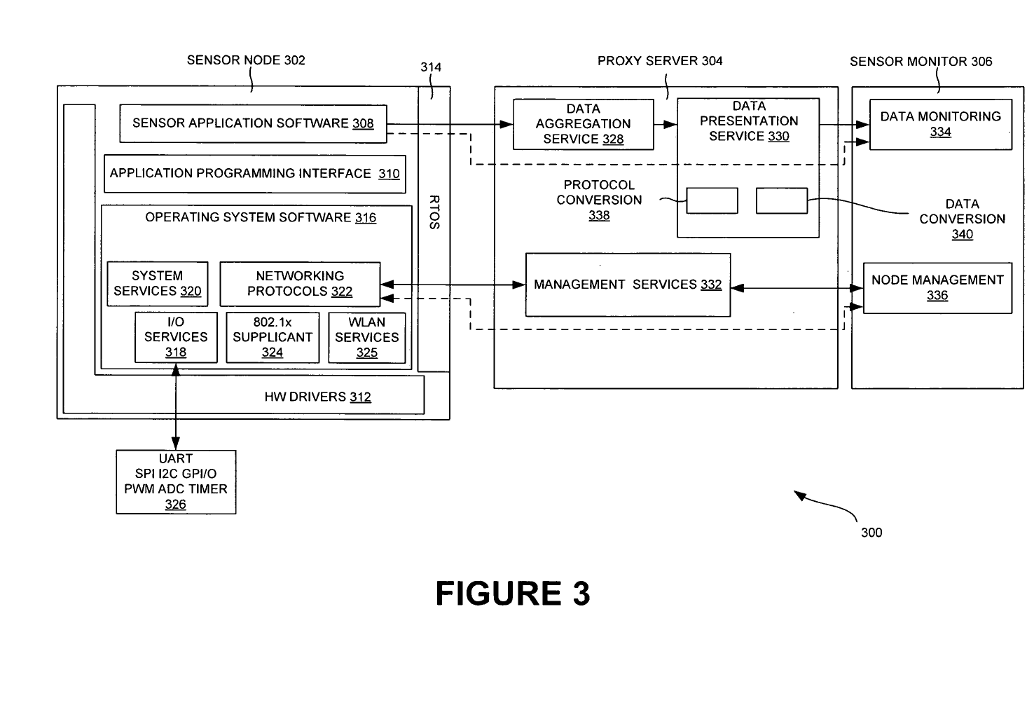

FIG. 3 is an interaction diagram of software modules of the low power wireless SOC of FIG. 2, according to one embodiment. A sensor node 302 may denote the location of a particular sensor (e.g., and/or other external devices) connected to the low power wireless SOC 200. The sensor node 302 may contain a sensor application software 308 which may be used to control the sensor (e.g., and/or other external devices) via a real-time operating system (RTOS) 314. The RTOS 314 may be a class of operating system intended for real-time applications. The RTOS 314 may operate on the hardware (HW) using hardware (HW) drivers 312. An operating system software 316, which may include system services 320, which may act as an intermediary between the RTOS 314 and the HW drivers 312, networking protocols 322, a 802.1x supplicant 324, WLAN services 325 and I/O services 318 via a UART, SPI, 12C, GPI/O, PWM, ADC, TIMER, etc. 326.

The sensor application software 308 may transmit the data to a proxy server 304 which may be used to manage communication of data and/or operation commands between the sensor node 302 and a sensor monitor 306. In one example embodiment, the data may be transmitted directly from the sensor application software 308 to the sensor monitor 306 (e.g., thus not requiring the service of the proxy server 304). In the proxy server 304, the data may be stacked in a data aggregation service 328 and/or may be organized and formatted in a data presentation service 330 so that it may be communicated to the sensor monitor 306.

The proxy server 304 may remove the latency for an acknowledgement (ACK) to the sensor node 302, thus saving power of the sensor node 302. The proxy server 304 may also hold messages from other systems (e.g., a network management system, a programmable logic controller, a supervisory control and data acquisition, etc.) until the sensor node 302 wakes up and requests the messages (e.g., thus reducing latency and saving power of the sensor node 302).

A management services module 332 in the proxy server 304 may be used to manage communication between the sensor node 302 and the sensor monitor 306. The data may finally be presented to the data monitoring module 334 (e.g., in the sensor monitor 306) which performs data processing/analysis based on an operator and/or a software within the data monitoring module 334 to issue commands to the sensor node 302.

FIG. 4 is a state diagram of the low power wireless SOC 200 of FIG. 2, according to one embodiment. A dead state 402 may imply that no power source is connected to the system. When a battery 404 is plugged in, the real time clock (RTC) 208 may be powered up and the low power wireless SOC 200 makes a transition from the dead state 402 to a stand-by state 406. The RTC 208 may be supplied directly from a battery (e.g., a battery plugged 404). Here, the low power wireless SOC 200 may show the lowest power consumption. The stand-by state 406 may be entered between active phases. When a power up request 408 is made by the RTC module, the low power wireless SOC 200 makes a transition from the stand-by state 406 to a system configuration state 412.

To switch on the low power wireless SOC 200, a DC/DC converter (e.g., regulating a voltage input to the low power wireless SOC 200) needs to be on, the power isolation from the RTC 208 needs to be removed, and/or a 44 MHz oscillator needs to be switched on. In this state, only a reset of the WLAN subsystem may get released by the RTC 208. The WLAN CPU may execute required system configurations before the low power wireless SOC 200 moves on to a general operation state, through another power-up request 414 to switch to a power-on state 417. The system configuration state 412 may also make a transition from the power-on state 417 to the system configuration state 412 using a power-down request and/or a firmware update request 416.

Another power-down request 410 may be made to make a transition from the system configuration state 412 to the stand-by state 406. The power-on state 417 may be an active state where the low power wireless SOC 200 is running. The power-on state 417 may have various sub-states, when unused parts of the system may be programmed to be in a non-operational mode reducing power consumption. These sub-states may be combined in a sleep state, which may be generically defined as a low-power condition. The several sub-states of sleep (e.g., the APP RUN WLAN SLEEP 422, the WLAN RUN APP SLEEP 428, THE WLAN & APP SLEEP 434, and THE DEEP SLEEP 438) may result in several scenarios as can be observed in FIG. 4.

The common characteristic of the sleep states may be that both the system voltage and the system clock are available, but the clock to specific parts of the system may be gated. For instance, one of the processors might be in a wireless fidelity (Wi-Fi) mode with its clock gated, while the other processor may be running. The system may be in the deep-sleep state 438 when all parts of the core system are in the sleep state and the 44 MHz oscillator may be switched off. Furthermore, the low power wireless SOC 200 of FIG. 2 draws about 3 micro amps during the deep-sleep state compared to 300 milliamps drawn by the low power wireless SOC 200 when the rest of the hardware module is operational

FIG. 5 is a system diagram of a control point 506 managing wireless devices 508 associated with a central base station 502 in a wireless network 500, according to one embodiment. Particularly, FIG. 5 illustrates the wireless network 500, the central base station 502, a host server 504, the control point 506, the wireless devices 508 (e.g., which may include the low power wireless SOC 200 of FIG. 2), an auxiliary base station 510, an auxiliary server 512, an auxiliary control point 514, a liveness module 516, a store and forward module 518, an access module 520, a remote module 522, an aggregation module 524, and a presentation module 526.

The wireless network 500 may be a Wireless Local Area Network (WLAN), a Global System for Mobile Communications (GSM), a Personal Communication Service, a Digital Advanced Mobile Phone Service (D-AMPS), a Wi-Fi, and/or a Fixed Wireless Data Network.

The central base station 502 may be a radio receiver/transmitter that serves as a hub of the local wireless network, a gateway between a wired network and the wireless network 500 and/or a two-way radio installation in a fixed location that may be used to communicate with one or more of the wireless devices 508. The host server 504 may be a computer that enables communication between the host server 506 and the wireless devices 508 and/or among the wireless devices 508. The control point 506 (e.g., which may reside in an access point, a radius sever, a proxy server, a host server, etc.) may be a protocol, and/or an algorithm that directs an operation of the host server 504 (e.g., thus managing nodes of the network, their resources, and/or enabling communication to other control points in the network). The wireless devices 508 (e.g., which may be sensors such as a temperature sensor, a humidity sensor, a motion sensor, etc.) may include a low-power two-way radio (e.g., which may be featured in the low power system on chip 114 of FIG. 1 embedded in the wireless devices 508). The auxiliary base station 510 may be a radio transmitter/receiver which serves as a backup base station of the wireless network 500. The auxiliary server 512 may serve as a backup server to the host server 504 which is used to enable communication the host server 506 and the wireless devices 508 and/or among the wireless devices 508. The auxiliary control point 514 may be a backup management module to the control point 506 (e.g., which may be a protocol, and/or an algorithm that may direct an operation of the host server 504).

In one example embodiment, the central base station 502, the host server 504, and/or the control point 506 may form a system that eases the management, configuration and/or deployment of the wireless devices 508. The system may enable communication between the host server 506 and the wireless devices 508 and/or among the wireless devices 508 which may be intermittently active. The wireless devices 508 may communicate periodically (e.g., and/or aperiodically) with the central base station 502. This periodic communication may be infrequent enough to minimize an impact on a battery life and/or power consumption of the wireless devices 508, but may also be frequent enough to allow wireless devices 508 that are removed (e.g., thrown out, broken, and/or taken away) to be automatically removed from the wireless network 500 when the central base station 502 does not receive their periodic communication message. This periodic communication may also provide regular opportunities to send configuration messages and/or firmware updates to the wireless devices 508, and/or to enact actions on the wireless devices 508. Because the periodic communication may be a regular event, this provides a means to ensure that any of the tasks (e.g., of changing functions or states) may be accomplished within a specified time, which may not be available currently when a person relies on the wireless devices 508 to initiate communication.

In another example embodiment, a system of the wireless network 500 may include one or more devices (e.g., the wireless devices 508) separately generating a heartbeat signal and the control point (e.g., the control point 506) communicating with the devices (e.g., through the wireless network 500) upon processing the heartbeat signal (e.g., which indicates that the devices 508 are ready to communicate with the control point 506).

A data packet containing the periodic reading of temperature data by a device may act as the heartbeat signal. The data packet not only reports the temperature reading of the device but also lets the control point to know that the device is alive and communicating. The control point 502 may include a number of modules used to manage the wireless devices 508. The liveness module 516 of the control point 506 may update a status of the wireless devices 508 based on the heartbeat signal. For instance, when a particular wireless device misses too many heartbeat signals, the liveness module will delete the particular wireless device from an active device list.

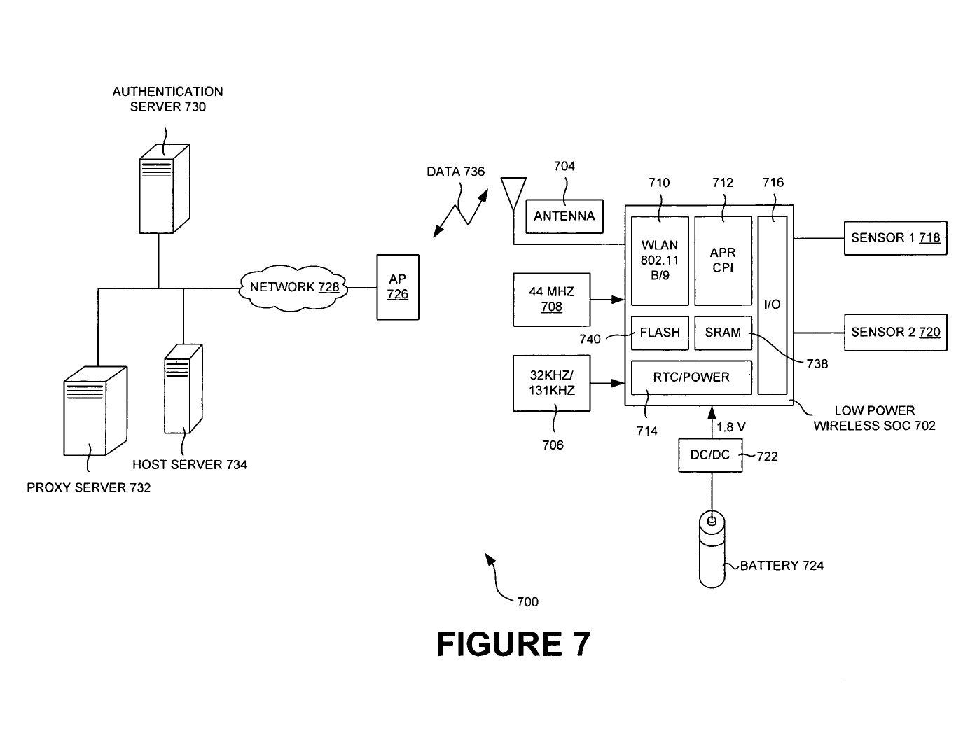

The store and forward module 518 of the control point 506 may communicate the device data of a wireless device 508A to another wireless device 508B through temporality holding the device data of the wireless device 508A until the another wireless device 508B is ready to process (e.g., receive) the device data. The access module 520 of the control point 506 may provide a tiered access (e.g., read, write, edit, etc.) to a user of the wireless network 500 through collaborating with an authentication server (e.g., the authentication server 730 of FIG. 7). The remote module 522 of the control point 506 may enable the user to log on to the control point 506 from any node of the wireless network 500. The aggregation module 524 of the control point 506 may aggregate data from a subset of the wireless devices 508. The presentation module 526 of the control point 506 may present the data (e.g., combined using the aggregation module 524) using the protocol conversion 338 and/or the data conversion 340 (e.g., changing the unit of temperature from Celsius to Farenheight) of FIG. 3.

In yet another example embodiment, the auxiliary control point 514 may replace the control point 506 when the control point 506 fails to communicate with the auxiliary control point 514. An internet protocol address of the control point 506 may be assumed by the auxiliary control point 514. To prepare for a possible transition from the control point 506 to the auxiliary control point 514, the control point may periodically update a status of individual wireless device (e.g., of the wireless devices 508) to the auxiliary control point 514.

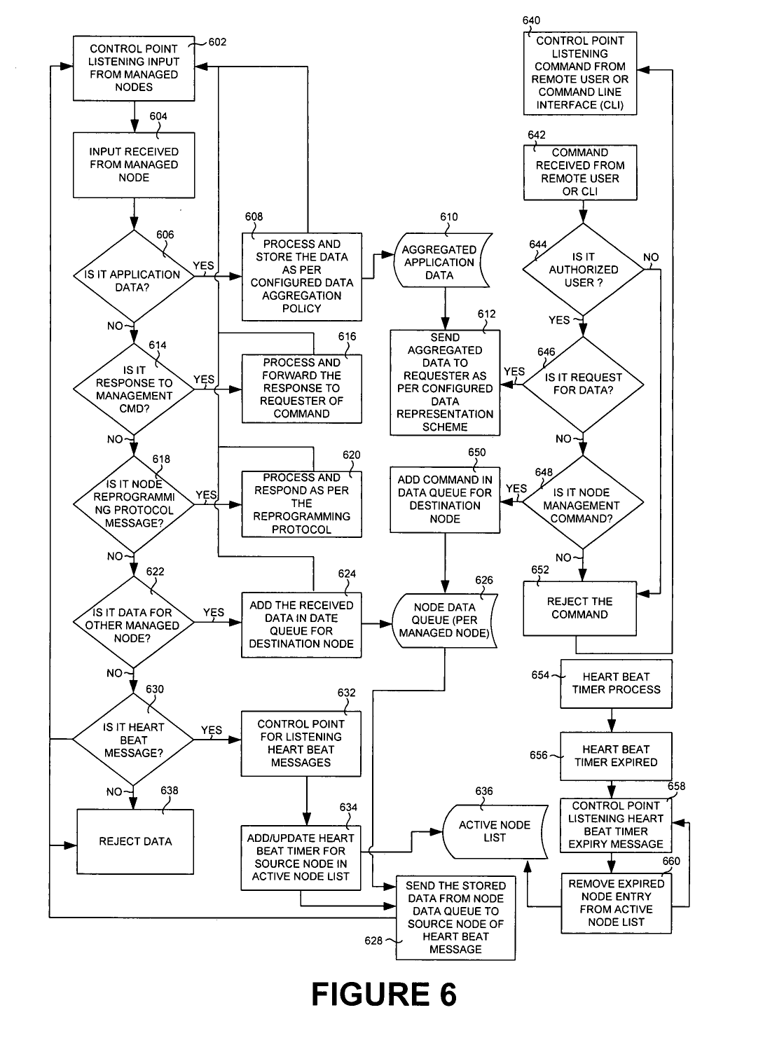

FIG. 6 is a process flow diagram of an algorithm implemented in the control point 506 of FIG. 5 to perform one or more functions associated with the wireless devices 508, according to one embodiment. In operation 602, the control point 506 may listen for input (e.g., data) from managed nodes (e.g., the wireless devices 508 and/or wired devices). In operation 606, the input received from the managed nodes (e.g., of operation 604) may be checked to determine whether it is application data. If the input is indeed the application data, the application data may be processed and/or stored in operation 608 according to a configured data aggregation policy. An aggregation of the application data (e.g., in operation 610) in addition to other application data is communicated to a requester (e.g., one or more of the managed nodes) according to a configured data representation scheme in operation 612.

If the input is a response to a management command of the control point in operation 614, the response may be processed and/or forwarded to the requester (e.g., one or more of the managed nodes) of the management command in operation 616. If the input is a node reprogramming protocol message in operation 618, the input may be processed and/or responded according to a reprogramming protocol (e.g., of the control point 506). If the input happens to be a data for other managed node in operation 622, the input (e.g., the received data) may be added in a data queue for a destination node (e.g., the other managed node) in operation 624. Stored data in the data queue (e.g., in operation 626) may be communicated (e.g., sent) to the destination node (e.g., a source node of the heartbeat message) in operation 628 when a heartbeat message of the destination node is detected by the control point 506.

If the input is the heartbeat message in operation 630, the heartbeat message may be detected by the control point 506 in operation 632. In operation 634, the heartbeat timer of the managed node (e.g., the source node) may be added and/or updated in an active node list (e.g., of operation 636) in operation 634. When the heartbeat message is heard by the control point 506, stored data in the data queue (e.g., for the managed node) may be sent to the managed node in operation 628. In one example embodiment, the managed node (e.g., the wireless devices 508) and the control point 506 may exchange security keys to authenticate the managed node and/or the control point 506 when the managed node and/or the control point 506 is newly added to the wireless network 500. If the input is not a meaningful data (e.g., the application data, the response to the management command, the node reprogramming protocol message, the data for other managed node, and/or the heartbeat message), the input may be rejected in operation 638.

In operation 640, the control point 506 may listen for a command from a remote user and/or a command line interface (CLI). If the remote user or the CLI is an authorized user in operation 644 (e.g., based on the command received from the remote user or the CLI in operation 642), the command may be checked to determine whether it is a request for data in operation 646. If the command is the request for data, an aggregation of data may be communicated to the remote user or CLI according to a configured data representation scheme in operation 612. If the command is a node management command in operation 628, the command may be added to the data queue of the destination node (e.g., of the remote user or CLI) in operation 650. Then, stored data of the data queue of the destination node may be communicated to the destination node (e.g., of the remote user or CLI) when the heartbeat message (e.g., of the destination node) is detected by the control point 506 in operation 628. If the remote user or CLI is not an authorized user in operation 644, the command may be rejected in operation 652.

In operation 654, the heartbeat timer may be processed for each managed node (e.g., the wireless device 508 and/or a wired device). If the heartbeat message (e.g., data, signal, etc.) of a particular node is not heard by the control point 506 within a threshold time, the heartbeat timer may be expired in operation 656. In operation 658, the control point may process a message indicating that the heartbeat timer has expired. Then, the particular node may be removed from the active node list in operation 660.

FIG. 7 is a low power wireless SOC 700 interacting with a host server 734 through an access point 726, according to one embodiment. An antenna 704 may be used to receive and/or transmit data 736 to and/or from the access point 726 (e.g., the gateway 110 of FIG. 1). A 32 kHz/131 kHz low-power crystal oscillator 704 may be used to drive a real time counter (RTC) 714 and a 44 MHz oscillator 708 may be used to drive a WLAN 710 and application (APP) CPUs. A flash memory 740 and a SRAM 738 may be used for a firmware update and/or a key management in encryption/decryption cores.

The RTC 714 may be also used to provide global time and date to the low power wireless SOC 700 (e.g., which may have a dedicated power supply). In one example embodiment, the low power wireless SOC 700 may be connected to two sensor devices (e.g., a sensor 1 718 and a sensor 2 720) via an I/O interface 716. The low power wireless SOC 700 may be powered by a battery 724 via a DC/DC converter 722 which converts the battery voltage to 1.8 V required for the operation of the low power wireless SOC 700.

In FIG. 7, data communication may take place between the sensors and the AP 726 via the low power wireless SOC 700 (e.g., which may be compliant with the IEEE 802.11). The AP 726 may be connected via a network 728 to an authentication server 730 (e.g., which may be used to provide authentication services to the host server 734), a proxy server 732, etc.

Furthermore, one or more external devices (e.g., the sensor 1 718, the sensor 2 720, etc.) may perform one or more functions based on a control signal processed in each of the one or more external devices. The low power wireless SOC 700 having the RTC 714 (e.g., which is communicatively coupled to the one or more external devices) may periodically generate the control signal during a non-operational stage (e.g., and/or during an operational stage) of the low power wireless SOC 700 to minimize a power consumption. In addition, the WLAN 710 may communicate with the access point (AP) 726 using a radio (e.g., conforming to 802.11 a/b/g standard) based on an alarm signal generated by the each of the one or more external devices.

In one example embodiment, the periodic heartbeat signal may be generated using a counter (e.g., the real time counter 714) of a system on chip (e.g., the low power wireless system on chip 700) embedded in the device (e.g., the sensor 1 718, the sensor 2 720, etc.). The heartbeat signal may be communicated to the control point (e.g., the control point 506) managing the device to trigger a communication between the device and the control point (e.g., which may reside in the host server 734). The system on chip may also be awakened (e.g., using the real time counter 714 of the system on chip 700) to generate the heartbeat signal when the counter of the system on chip reaches a preset value.

In another example embodiment, the real time counter module (e.g., the real time counter 714) may be used to count clock pulses of the system on chip (e.g., the system on chip 700) embedded in a device (e.g., the sensor 1 718, the sensor 2 720, etc.). Also, a heartbeat module coupled to the real time counter module may be used to generate a heartbeat signal (e.g., where the heartbeat signal is periodically and/or aperiodically communicated to the control point such that a presence of the device is confirmed by the control point based on the heartbeat signal) when a number of the clock pulses is equivalent to the preset value to trigger a communication between the device and a control point managing the device.

Signal data of the control point may be communicated subsequent to the heartbeat signal to control the device based on the heartbeat signal. The system on chip may also be placed back to the sleep mode when the heartbeat signal is communicated to the control point to minimize a power consumption of the system on chip.

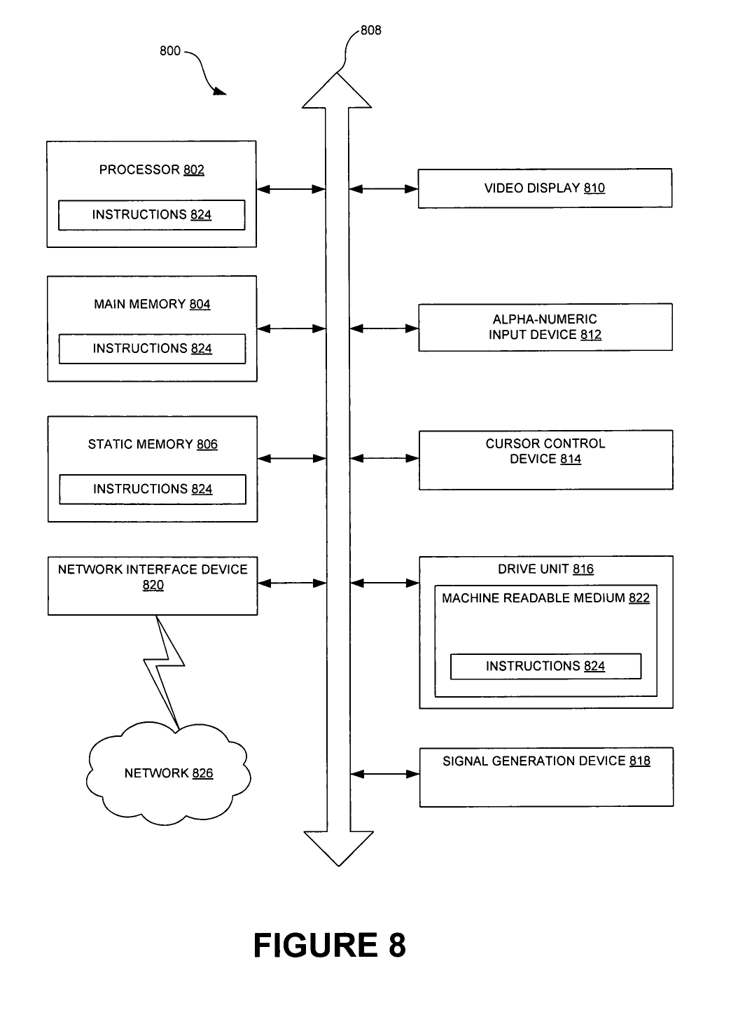

FIG. 8 is a diagrammatic representation of a computer system 800 capable of processing a set of instructions to perform any one or more of the methodologies herein, according to one embodiment. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment.

The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 800 includes a processor 802 (e.g., a central processing unit (CPU) a graphics processing unit (GPU) and/or both), a main memory 804 and a static memory 806, which communicate with each other via a bus 808. The computer system 800 may further include a video display unit 810 (e.g., a liquid crystal display (LCD) and/or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions (e.g., software 824) embodying any one or more of the methodologies and/or functions described herein. The software 824 may also reside, completely and/or at least partially, within the main memory 804 and/or within the processor 802 during execution thereof by the computer system 800, the main memory 804 and the processor 802 also constituting machine-readable media.

The software 824 may further be transmitted and/or received over a network 826 via the network interface device 820. While the machine-readable medium 822 is shown in an example embodiment to be a single medium, the term “machine-readable medium” should be taken to include the single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

Although the present embodiments have been described with reference to specific example embodiments, it will be evident that various modifications and changes may be made to these embodiments without departing from the broader spirit and scope of the various embodiments. For example, the various devices, modules, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

Also, the method may be in a form of a machine-readable medium embodying a set of instructions that, when executed by a machine, cause the machine to perform any method disclosed herein. It will be appreciated that the various embodiments discussed herein may/may not be the same embodiment, and may be grouped into various other embodiments not explicitly disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than restrictive sense.

What is claimed is:

1. A method of a control point in a network, comprising:
monitoring a heartbeat signal of a device communicated through the network; and
communicating with the device upon processing the heartbeat signal of the device.

2. The method of claim 1, further comprising removing the device from an active device list of the control point when a heartbeat signal of the device is not detected past a threshold value.

3. The method of claim 1, wherein the control point resides in at least one of an access point, a radius server, a proxy server, and a host server in the network.

4. The method of claim 1, further comprising temporarily holding data destined for the device in a data queue associated with the control point until the processing the heartbeat signal is completed or the device is ready to process the data.

5. The method of claim 1, further comprising authenticating the device or the control point through exchanging security keys between the device and the control point.

6. The method of claim 1, further comprising enabling a user to access the control point from a remote location in the network.

7. The method of claim 1, further comprising communicating a command data to the device to alter a state or function of the device.

8. The method of claim 1 in a form of a machine-readable medium embodying a set of instructions that, when executed by a machine, causes the machine to perform the method of claim 1.

9. A system, comprising:
a plurality of devices to individually generate a heartbeat signal; and
a control point to communicate with each of the plurality of devices through a network based on the heartbeat signal processed through the control point,
wherein the heartbeat signal to indicate a wake-up mode of the each of the plurality of devices.

10. The system of claim 9, further comprising a liveness module of the control point to update a status of the each of the plurality of devices based on the heartbeat signal.

11. The system of claim 9, further comprising a store and forward module of the control point to communicate a device data of a first device of the plurality of devices to a second device of the plurality of devices.

12. The system of claim 11, wherein the store and forward module temporarily holds the device data communicated from the first device until the second device is ready to process the device data.

13. The system of claim 9, further comprising an auxiliary control point to replace the control point when the control point fails to communicate with the auxiliary control point, wherein an internet protocol address of the control point is assumed by the auxiliary control point replacing the control point.

14. The system of claim 13, wherein the control point periodically communicates a status of the each of the plurality of devices to the auxiliary control point.

15. The system of claim 9, further comprising an access module of the control point provides a tiered access to a user of the system through collaborating with an authentication server communicatively coupled to the access module.

16. The system of claim 9, further comprising a remote module of the control point enables a user of the system to log on to the control point from any node of the network.

17. The system of claim 9, further comprising an aggregation module of the control point to aggregate data from any subset of the plurality of devices.

18. The system of claim 17, further comprising a presentation module of the control point to present the data from the any subset of the plurality of devices.

19. The system of claim 9, wherein the control point to reside any node in the network including at least an access point, a radius server, a proxy server and a host server.

20. An apparatus, comprising:
a control point to communicate with a device upon processing a heartbeat signal of the device,
wherein a status or a function of the device is updated upon authenticating the control point or the device based on the heartbeat signal.
